(19) United States
(12) Patent Application Publication
(10) Pub. No.: US 2006/0048067 A1
(43) Pub. Date: Mar. 2, 2006

(54) System and method for increasing the available workspace of a graphical user interface

(75) Inventors: Stuart Nelsen DeSpain, Seattle, WA (US); Viswanath Sankaranarayanan, Bellevue, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 10/930,365

(22) Filed: Aug. 31, 2004

(51) Int. Cl. G06F 17/00

(52) U.S. Cl. 715/768

(57) ABSTRACT

An improved system and method for increasing the available workspace of a graphical user interface by providing reduced opacity of an element in the graphical user interface to make the workspace beneath the semi-transparent element visible. Later, the semi-transparent element may be made opaque again for better visibility to a user. An opacity manager may be operably coupled to a graphics interface of an operating system to change the opacity of an element of the graphical user interface. Any type of element of a graphical user interface may have its opacity reduced, including a window, a dialog box, a message box, a toolbar, a control, a button, a menu, and so forth. The system and method may reduce or increase the opacity of an element of the graphical user interface in response to any event including a system event, an application event, or a user interface event.

### FIELD OF THE INVENTION

The invention relates generally to computer systems, and more particularly to an improved system and method for increasing the available workspace of a graphical user interface by reducing the opacity of an element in the graphical user interface to make the workspace beneath the element visible.

### BACKGROUND OF THE INVENTION

Existing desktop management software and graphical user interfaces have long struggled with providing easily accessible tools to a user, yet keeping as much available workspace as possible for a particular task or focus of a user. In an effort to do so, many different techniques have been developed for providing additional workspace for a particular task or focus of a user. Among the techniques are tiling windows, reducing a window or object in size, replacing a window or object with an icon, closing a window or object, and so forth. However, these techniques generally obscure or may even remove a useful tool from the desktop to gain the additional workspace.

Another approach taken to provide as much available workspace as possible is to limit objects on the desktop to the current focus or task of the user. For example, one technique allows the user to organize the desktop in explicit multiple workspaces. Each workspace may be given a name and the user may simply move from one workspace to the other by clicking on the name in a menu. Another example of limiting objects on the desktop to the focus or task of the user in the workspace is to group various tools into a specialized toolbar such as formatting tools, drawing tools, picture tools, web tools, and so forth. The user then may select which set or sets of tools appear in the toolbar in the workspace.

Although these approaches and techniques have successfully provided additional workspace for the user, it may be at the expense of displaying a useful element of a graphical user interface, such as a tool or object. What is needed is a way for increasing workspace without removing a useful element of a graphical user interface from the display.

### SUMMARY OF THE INVENTION

Briefly, the present invention provides a system and method for increasing the available workspace of a graphical user interface by providing reduced opacity of an element in a graphical user interface to make the workspace beneath the semi-transparent element visible. To this end, an opacity manager may be operably coupled to a graphics interface of an operating system to change the opacity of an element of the graphical user interface. Any type of element of a graphical user interface may have its opacity reduced, including a window, a dialog box, a message box, a toolbar, a control, a button, a menu, and so forth. Moreover, a monitor may be provided for being notified of an event and the monitor may be operably coupled to the opacity manager for sending the event to the opacity manager. The monitor may be notified of any type of event, including system events, application events and user interface events.

The present invention additionally provides a method for reducing the opacity of an element in a graphical user interface so that a semi-transparent element may reveal the workspace beneath the element. One or more requests may be sent for changing the opacity of an element in a graphical user interface. In one embodiment, each request may specify an incremental decrease in the opacity of the element of the graphical user interface. Alternatively, each request may specify an incremental decrease in the opacity of the element until the opacity of the element reaches a target opacity. The present invention also provides a method for increasing the opacity of an element in a graphical user interface for making the element opaque. In one embodiment, each request may specify an incremental increase in the opacity of the element for making the element opaque. Alternatively, each request may specify an incremental increase in the opacity of the element until the opacity of the element reaches a target opacity.

Advantageously, the system and method may reduce the opacity of an opaque element in a graphical user interface so that the element becomes semi-transparent to reveal the workspace beneath the element to a user. Later, the semi-transparent element may be made opaque again for better visibility to a user. The system and method may reduce or increase the opacity of an element of the graphical user interface in response to any event including a system event, such as switching application windows, or a user interface event, such as mousing over the element. This is particularly useful for providing visible tools, applications or content to a user while increasing the available workspace of a graphical user interface.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for reducing opacity of an element in the workspace of a graphical user interface, in accordance with an aspect of the present invention;

FIG. 3 is a flowchart generally representing the steps undertaken for reducing opacity of an element in the workspace of a graphical user interface, in accordance with an aspect of the present invention;

FIG. 4 is a flowchart generally representing the steps undertaken for gradually fading an element in the workspace of a graphical user interface to reduce opacity in one embodiment, in accordance with an aspect of the present invention;

FIG. 5 is a flowchart generally representing the steps undertaken for increasing opacity of an element in the workspace of a graphical user interface, in accordance with an aspect of the present invention; and

FIG. 6 is an exemplary illustration generally representing a screen of a workspace with an element of the graphical user interface displayed with reduced opacity, in accordance with an aspect of the present invention.

### DETAILED DESCRIPTION

Exemplary Operating Environment

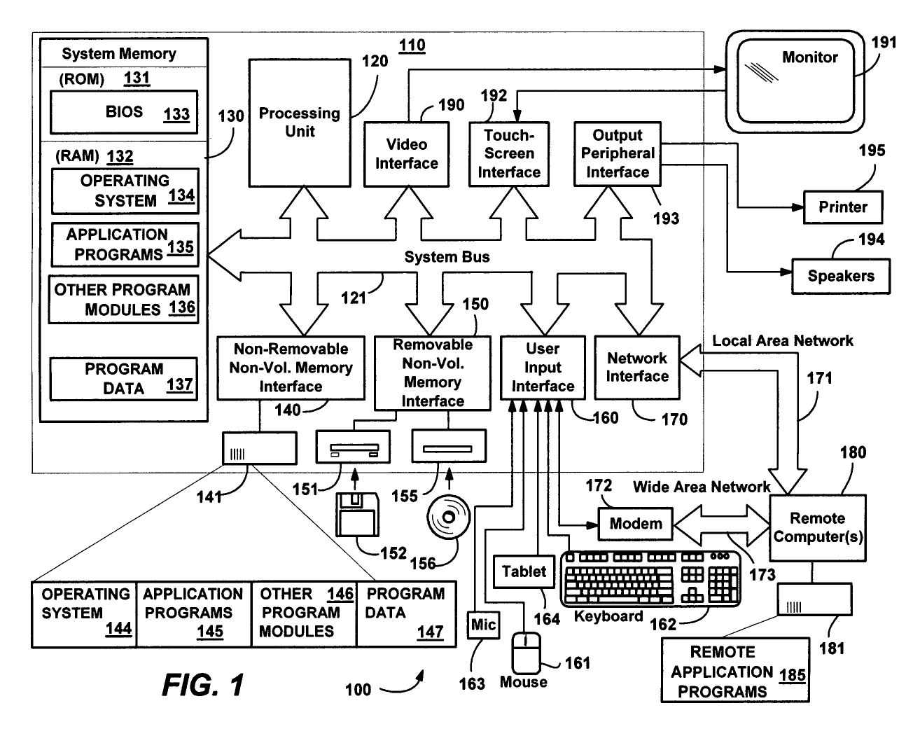

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, headless servers, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or other devices including a device that contains a biometric sensor, environmental sensor, position sensor, or other type of sensor. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Reducing Opacity of an Element in the Workspace of a Graphical Use Interface

The present invention is generally directed towards a system and method for increasing the available workspace of a graphical user interface by providing reduced opacity of an element in a graphical user interface to make the workspace beneath the element visible. As used herein, an element in the workspace of a graphical user interface means any graphical user interface object such as a window, including without limitation, an application window, a dialog box, a message box, a toolbar, a control, a button, a menu, and so forth. In addition to a graphical user interface object such as a window, an element may also include a pane or frame of a window. As will be seen, the invention provides a user configurable system and a method for reducing and restoring opacity of an element in the workspace of a graphical user interface. As will be understood, the various block diagrams, flow charts and scenarios described herein are only examples, and there are many other scenarios to which the present invention will apply.

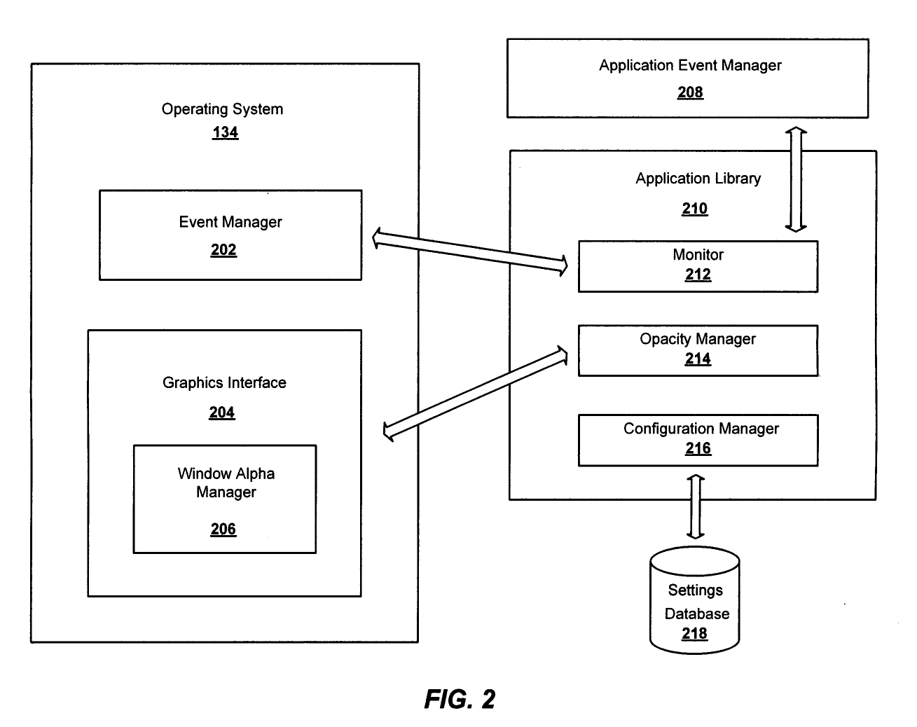

Turning to FIG. 2 of the drawings, there is shown a block diagram generally representing an exemplary architecture of system components for changing the opacity of any element in the workspace of a graphical user interface. For instance, the opacity of any element in the workspace of a graphical user interface may be changed by reducing the opacity to provide any level of transparency desired for revealing the workspace beneath the element. The opacity of any element in the workspace may also be changed by increasing the opacity to make the element more opaque. Those skilled in the art will appreciate that the functionality implemented within the blocks illustrated in the diagram may be implemented as separate components or the functionality of several or all of the blocks may be implemented within a single component. For example, the functionality of the monitor 212 may be included in the opacity manager 214. Or the functionality for the configuration manager 216 of the application library 210 may be implemented as a separate component.

A typical operating system 134 may include an event manager 202 for handling system events and a graphics interface 204 which may provide the core functionality for managing the windows displayed as part of the graphical user interface. The event manager 202 and the graphics interface 204 may be software components of the operating system 134 as illustrated in FIG. 2. However, the functionality of the event manager 202 and the graphics interface 204 may be included in any type of executable software code such as a kernel component, an application program, a linked library, and so forth. A system event handled by the event manager 202 may include user interface events such as an input event generated by a user interacting with the graphical user interface. The core functionality provided for managing the windows by the graphics interface 204 may include functionality for opening, closing, maximizing, minimizing, resizing and moving a window. Among the functionality provided may be a manager, such as window alpha manager 206, for setting the alpha channel value for a window. This value may control the opacity of a window which can typically range from 0.0 for complete transparency to 1.0 for full opacity.

Also illustrated in FIG. 2 are an application event manager 208 and an application library 210. The application event manager and the application library may be any type of executable software code such as a kernel component, an application program, a linked library, and so forth. The application event manager 208 may handle events for the application library 210 and other executable code such as application programs. The application library 210 may include a monitor 214, an opacity manager 214, and a configuration manager 216.

In specific, the monitor 212 may be operably coupled with the event manager 202 and the application event manager 208 to receive notification of events. The events received may be, for example, the expiration of a timer, a system event, some user interface event such as a mouse over, keyboard input, positioning a cursor on an edit field, content selection, or other types of events. The opacity manager 214 may provide functionality for reducing and increasing the opacity of an element of the workspace in a graphical user interface and may be operably coupled with the graphics interface 204 for requesting setting of an alpha channel value for a window. In one embodiment, the opacity manager may fade the element by gradually decreasing the alpha channel value of a window until the element is semi-transparent. And the configuration manager 216 may be operably coupled to the settings database 218 for storing user configurable settings for reducing and increasing the opacity of an element of the workspace.

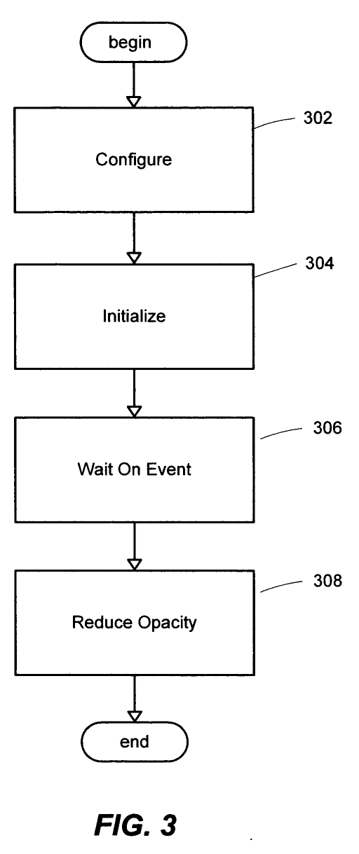

FIG. 3 presents a flowchart generally representing the steps undertaken for reducing opacity of an element in the workspace of a graphical user interface. At step 302, one or more settings may be configured for reducing the opacity of an element in the workspace. In one embodiment, the settings may include the target opacity, the amount to fade, the time interval between each fade amount, events for reducing opacity, and so forth. In addition to settings, events that may initiate reducing opacity of an element in the workspace may also be configured. For instance, the occurrence of system events, application events and user interface events may initiate reducing opacity of an element in the workspace. Or a period of inactivity of the element may initiate reducing it opacity. In another embodiment, one or more settings may also be configured for increasing the opacity of an element in the workspace such as the target opacity, the amount to make more opaque, the time interval between each increase in the amount to make more opaque, events for increasing opacity, and so forth.

Next, the settings may be initialized at step 304 for an element in the workspace. Default settings may be used where setting have not been configured by a user. In one embodiment, for example, the default target opacity may be set to 67% opacity. In this embodiment, for instance, there may be 1% fade every 0.1 seconds until reaching the target opacity of 67%. Once any desired settings are configured and the settings are initialized for an element of the workspace, then the system may wait upon an event at step 306 that may initiate reducing opacity. For example, the event may be a system event, such as an event to switch an application or an event to hide all windows, or a user interface event, such as mousing over the element in the workspace of the graphical user interface. Moreover, in one embodiment, an event may be user configurable. After notification of an event, the system may reduce the opacity of the element in the workspace at step 308.

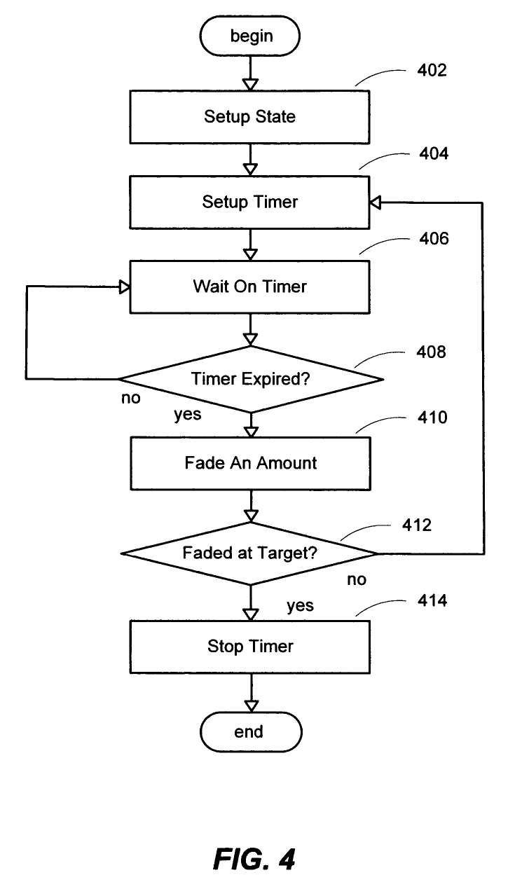

FIG. 4 presents a flowchart generally representing the steps undertaken for gradually fading an element in the workspace of a graphical user interface to reduce opacity in one embodiment of the present invention. At step 402, state variables may be assigned values. For instance, state variables such as the target opacity, the time interval between each fade amount, the amount to fade during each timer interval, and so forth, may be assigned values from the setting database 218. A timer may be setup to expire after an assigned time period at step 404 for establishing an interval between fading an amount of the element so that the element may be gradually faded at a certain percent during each interval until reaching a target opacity. In this exemplary embodiment, the timer may be set to expire every 0.1 seconds. Other time periods may be used for the interval in another embodiment. At step 406, the system may wait on the timer. The system may then check whether the timer has expired at step 408. If the timer has not expired, the system may return to step 406 and wait on the timer; otherwise, the system may proceed at step 410 to fade the element of the workspace an amount. In one embodiment, this may be accomplished by decreasing the alpha channel value for an element in the workspace. In this embodiment the amount may be 1% of opacity. Other percentages of opacity may be reduced in another embodiment. At step 412, the system may determine whether the element has faded to the target opacity. If so, the timer may be stopped at step 414 and the process is finished. If the element has not faded to the target opacity, then the system may return to step 404 and may reset the timer. The process may continue to fade the element an amount at each interval until the element has faded to the target opacity.

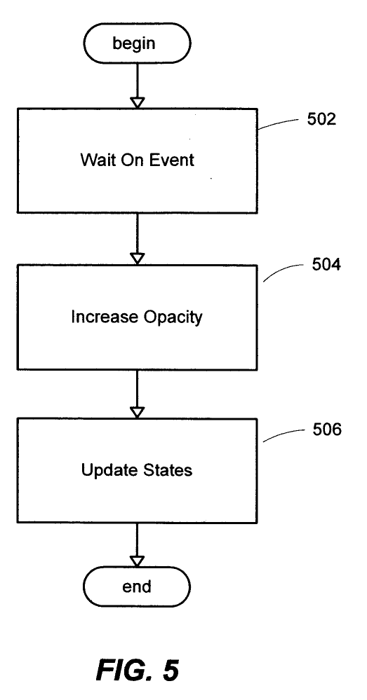

FIG. 5 presents a flowchart generally representing the steps undertaken for increasing opacity of an element in the workspace of a graphical user interface. The opacity of an element in the workspace of a graphical user interface may be increased to a target opacity upon the occurrence of an event. At step 502 the system waits on the occurrence of an event. The event may be any type of event such as a system event, an application event or a user interface event. After receiving an event, the system may increase the opacity of the element in the workspace at step 504. In one embodiment, this may be accomplished by increasing the alpha channel value for an element in the workspace. In another embodiment, the alpha channel value may be increased a percentage for a periodic time interval until the target opacity is reached. After the target opacity of the element is reached, the state variables may then be updated at step 506.

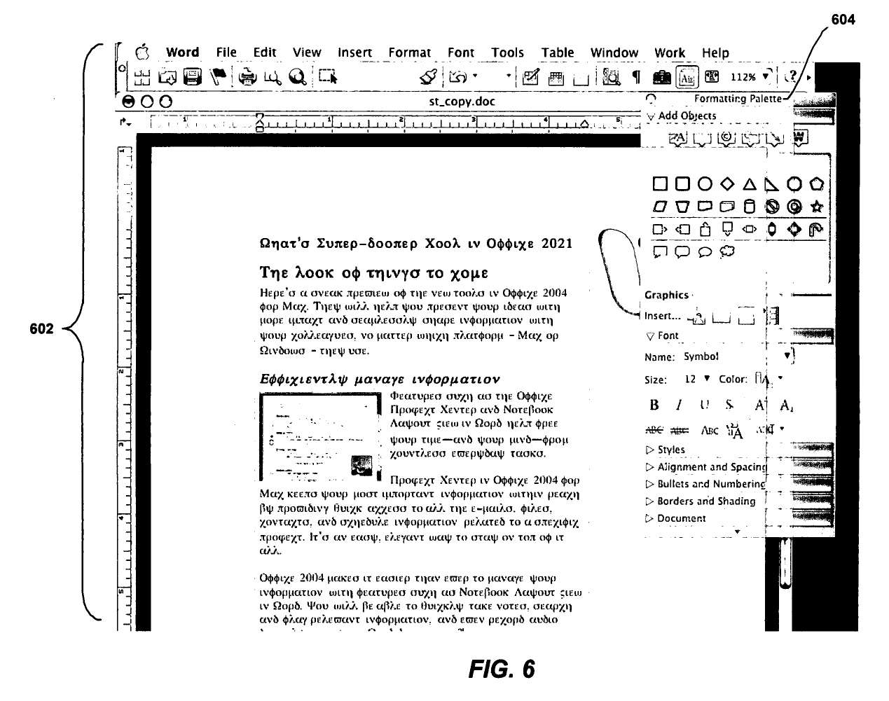

FIG. 6 presents an exemplary illustration generally representing a screen of a workspace with an element of the graphical user interface displayed with reduced opacity. The screen in FIG. 6 shows the window of a word processing application 602 with a formatting palette 604 displayed with reduced opacity so that the formatting palette is semi-transparent and reveals the workspace beneath it. In one embodiment, a user may have initiated reducing the opacity of the formatting palette 604 by moving the cursor of a mouse from the formatting palette 604 over the window of the word processor application 602. Later, a user may mouse over the formatting palette which may initiate the system to increase the opacity of the formatting palette so that it becomes opaque to provide better visibility to the user. Although FIG. 6 presents a tool, the formatting palette 604, as an example of an element in the workspace of a graphical user interface that may have its opacity decreased to reveal the workspace beneath and thereby increase the workspace of the desktop, those skilled in the art will appreciate that the present invention may be used with other elements in a workspace, including an application window, a window displaying content, a dialog box, a button, and so forth.

As can be seen from the foregoing detailed description, the present invention provides an improved system and method for increasing the available workspace of a graphical user interface by providing reduced opacity of an element in a graphical user interface and thereby making visible the workspace beneath the element. Furthermore, the system and method provided are flexible and extensible for reducing clutter on the desktop. For example, if an element of a graphical user interface has had its opacity reduced for a specified period of time, the element of the graphical user interface may also be removed from the workspace such as by closing a window, making the element completely transparent, or using another method. Any event may initiate returning the element either semi-transparent or fully opaque. As is now understood, the present invention may advantageously be used to increase the available workspace of a desktop while providing visible tools, applications or content to a user. Objects of the graphical user interface may remain on the desktop to provide easy access and yet minimize their intrusion when not being used. The system and method thus provide significant advantages and benefits needed in contemporary computing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for increasing the available workspace of a graphical user interface, comprising:
an opacity manager for sending a request to change the opacity of an element of the graphical user interface in response to receiving an event; and
a graphics interface operably coupled to the opacity manager for receiving the request to change the opacity of an element of the graphical user interface.

2. The system of claim 1 further comprising a monitor operably coupled to the opacity manager for sending the event.

3. The system of claim 2 further comprising an event manager operably coupled to the monitor for notifying the monitor of the event.

4. The system of claim 3 wherein the event comprises a system event.

5. The system of claim 3 wherein the event comprises a user interface event.

6. The system of claim 1 further comprising a configuration manager operably coupled to the opacity manager for storing user configurable settings.

7. The system of claim 1 further comprising a component operably coupled to the graphics interface for changing the opacity of an element of the graphical user interface.

8. A computer-readable medium having computer-executable components comprising the system of claim 1.

9. A method for increasing the available workspace of a graphical user interface in a computing device, comprising:
receiving an event;
in response to receiving the event, sending at least one request to change the opacity of an element of the graphical user interface for making the element semi-transparent to reveal the workspace beneath the element; and
changing the opacity of the element of the graphical user interface in response to the at least one request.

10. The method of claim 9 further comprising configuring the computing device for waiting on the event.

11. The method of claim 9 further comprising waiting on the event.

12. The method of claim 9 wherein receiving an event comprises receiving a system event.

13. The method of claim 9 wherein receiving an event comprises receiving a user interface event.

14. The method of claim 9 wherein sending at least one request to change the opacity of an element of the graphical user interface comprises sending several requests to change the opacity of the element of the graphical user interface, each request specifying an incremental decrease in the opacity of the element of the graphical user interface.

15. The method of claim 9 wherein sending at least one request to change the opacity of an element of the graphical user interface comprises sending several requests to incrementally change the opacity of the element of the graphical user interface until the opacity of the element reaches a target opacity.

16. The method of claim 15 further comprising setting a timer to expire at the end of a predetermined interval and waiting for the timer to expire before sending each of the several requests to incrementally change the opacity of the element of the graphical user interface until the opacity of the element reaches the target opacity.

17. The method of claim 9 wherein the element comprises a toolbar.

18. The method of claim 9 wherein the element comprises a window.

19. A computer-readable medium having computer-executable instructions for performing the method of claim 9.

20. A method in a computing device having a graphical user interface, comprising:
receiving an event;
in response to receiving the event, sending at least one request to change the opacity of a semi-transparent element of the graphical user interface for making the element opaque to obscure the workspace beneath the element; and
changing the opacity of the element of the graphical user interface in response to the at least one request.

21. The method of claim 20 further comprising configuring the computing device for waiting on the event.

22. The method of claim 20 further comprising waiting on the event.

23. The method of claim 20 wherein receiving an event comprises receiving a system event.

24. The method of claim 20 wherein receiving an event comprises receiving a user interface event.

25. The method of claim 20 wherein sending at least one request to change the opacity of an element of the graphical user interface comprises sending several requests to change the opacity of the element of the graphical user interface, each request specifying an incremental increase in the opacity of the element of the graphical user interface.

26. The method of claim 20 wherein sending at least one request to change the opacity of an element of the graphical user interface comprises sending several requests to incrementally change the opacity of the element of the graphical user interface until the opacity of the element reaches a target opacity.

27. The method of claim 20 further comprising setting a timer to expire at the end of a predetermined interval and waiting for the timer to expire before sending each of the several requests to incrementally change the opacity of the element of the graphical user interface until the opacity of the element reaches the target opacity.

28. A computer-readable medium having computer-executable instructions for performing the method of claim 20.

29. A method for increasing the available workspace of a graphical user interface in a computing device, comprising:
receiving a first event;
in response to receiving the first event, sending at least one request to change the opacity of an element of the graphical user interface for making the element semi-transparent to reveal the workspace beneath the element;
changing the opacity of the element of the graphical user interface in response to the at least one request to make the element semi-transparent to reveal the workspace beneath the element;
receiving a second event;
in response to receiving the second event, sending at least one request to change the opacity of the semi-transparent element of the graphical user interface for making the element opaque to obscure the workspace beneath the element; and
changing the opacity of the semi-transparent element of the graphical user interface in response to the at least one request to make the element opaque to obscure the workspace beneath the element.

30. The method of claim 29 further comprising configuring the computing device for waiting on the first event.

31. The method of claim 29 further comprising waiting on the first event.

32. The method of claim 29 further comprising configuring the computing device for waiting on the second event.

33. The method of claim 29 further comprising waiting on the second event.

34. The method of claim 29 wherein sending at least one request to change the opacity of an element of the graphical user interface for making the element semi-transparent to reveal the workspace beneath the element comprises sending several requests to change the opacity of the element of the graphical user interface, each request specifying an incremental decrease in the opacity of the element of the graphical user interface.

35. The method of claim 29 wherein sending at least one request to change the opacity of an element of the graphical user interface for making the element semi-transparent to reveal the workspace beneath the element comprises sending several requests to incrementally change the opacity of the element of the graphical user interface until the opacity of the element reaches a target opacity.

36. The method of claim 29 wherein sending at least one request to change the opacity of the semi-transparent element of the graphical user interface for making the element opaque to obscure the workspace beneath the element comprises sending several requests to change the opacity of the element of the graphical user interface, each request specifying an incremental increase in the opacity of the element of the graphical user interface.

37. The method of claim 29 wherein sending at least one request to change the opacity of the semi-transparent element of the graphical user interface for making the element opaque to obscure the workspace beneath the element comprises sending several requests to incrementally change the opacity of the element of the graphical user interface until the opacity of the element reaches a target opacity.

38. The method of claim 29 wherein the element of the graphical user interface comprises a window.

39. The method of claim 29 wherein the element of the graphical user interface comprises a toolbar.

40. A computer-readable medium having computer-executable instructions for performing the method of claim 29.
